(19) United States
(12) Patent Application Publication
(10) Pub. No.: US 2007/0005203 A1
(43) Pub. Date: Jan. 4, 2007

(54) Vehicle diagnostic system and method for monitoring vehicle controllers

(76) Inventors: Padma Sundaram, West Bloomfield, MI (US); Song You, Macomb, MI (US); Laci J. Jalics, Ray, MI (US); Joseph D'Ambrosio, Clarkston, MI (US)

Correspondence Address: DELPHI TECHNOLOGIES, INC., M/C 480-410-202, PO BOX 5052, TROY, MI, 48007, US

(21) Appl. No.: 11/471,259

(22) Filed: Jun. 20, 2006

Related U.S. Application Data
(60) Provisional application No. 60/695,334, filed on Jun. 30, 2005.

(51) Int. Cl. G06F 19/00

(52) U.S. Cl. 701/33; 701/29; 340/438

(57) ABSTRACT

A vehicle diagnostic system and a method for monitoring vehicle controllers are provided. The method includes generating a first message having a fault status value when a fault condition is detected, utilizing a first controller. The first controller controls a first device. The method further includes receiving the first message at a supervisory controller and sending a second message from the supervisory controller to a second controller indicating a second operational state for the second controller, in response to the first message. The method further includes transitioning an operational state of the second controller from a third operational state to the second operational state in response to the second message.

### CROSS REFERENCE TO RELATED APPLICATION

This application claims the benefit of U.S. Provisional Application No. 60/695,334, filed Jun. 30, 2005, the contents of which is incorporated by reference herein in its entirety.

### TECHNICAL FIELD

The present application relates to a vehicle diagnostics system and a method for monitoring vehicle controllers.

### BACKGROUND

Vehicles have numerous vehicle subsystems that perform certain functions associated with the vehicle. For example, vehicles can have a steering subsystem and a brake subsystem. Traditionally, each vehicle subsystem could perform a diagnostic test on itself and when a fault condition was internally detected, it would take internal corrective actions to minimize the effect of the fault condition. However, the vehicle did not utilize a supervisory controller to notify other vehicle subsystems that a fault condition in one of the vehicle subsystems has occurred and to coordinate corrective actions among more than one vehicle subsystem that could be affected by the fault condition.

Accordingly, the inventors herein have recognized a need for an improved vehicle diagnostic system that minimizes and/or eliminates the above-mentioned deficiencies.

### SUMMARY OF THE INVENTION

A vehicle diagnostic system in accordance with an exemplary embodiment is provided. The vehicle diagnostic system includes a first controller configured to control operation of a first device. The first controller has a first operational state. The first controller is configured to generate a first message having a fault status value when a fault condition is detected. The vehicle diagnostic system further includes a second controller configured to control operation of a second device. The second controller has a second operational state. The vehicle diagnostic system further includes a supervisory controller operably communicating with the first and second controllers. The supervisory controller is configured to receive the first message and to send a second message to the second controller indicating a third operational state for the second controller in response to the first message. The second controller is further configured to transition from the second operational state to the third operational state in response to the second message.

A method for monitoring vehicle controllers in accordance with another exemplary embodiment is provided. The method includes generating a first message having a fault status value when a fault condition is detected, utilizing a first controller. The first controller controls a first device. The method further includes receiving the first message at a supervisory controller and sending a second message from the supervisory controller to a second controller indicating a second operational state for the second controller, in response to the first message. The method further includes transitioning an operational state of the second controller from a third operational state to the second operational state in response to the second message.

### BRIEF DESCRIPTION OF THE DRAWINGS

FIG. 1 is a block diagram of a vehicle diagnostic system in accordance with an exemplary embodiment;

FIG. 2 is a schematic of a message format utilized in the vehicle diagnostic system of FIG. 1; and

FIGS. 3-6 are flowcharts of a method for monitoring controllers in accordance with another exemplary embodiment.

### DESCRIPTION OF EXEMPLARY EMBODIMENTS

A vehicle diagnostic system 10 for monitoring operation of vehicle controllers is illustrated. The vehicle diagnostic system 10 includes a supervisory controller 12, a brake controller 14, a steering controller 16, a speed sensor 20, a yaw sensor 22, a lateral acceleration sensor 24, a vehicle brake actuator 25, a steering wheel position sensor 26, a vehicle wheel position sensor 28, a steering actuator 29, and a communication bus 30.

The supervisory controller 12 is provided to monitor operation of the brake controller 14, the steering controller 16, and the various sensors and the actuators coupled to the controllers. Further, the supervisor controller 12 is provided to induce brake controller 14 and the steering controller 16 to enter into desired operational states, in response to detected fault conditions. Referring to FIG. 2, the supervisory controller 12 receives and transmits messages having the message format 40, to the brake controller 14 and the steering controller 16. The message format 40 includes the following fields: (i) Controller ID, (ii) Message ID, (iii), Current Subsystem State, (iv) Fault type, and (v) Commanded Subsystem State. The Controller ID field contains a unique identifier identifying a specific controller. For example, the Controller ID field is set equal to “1” for messages sent from the brake controller 16, the Controller ID field is set equal to “2” for messages sent from the steering controller 16, and the Controller ID field is set equal to “3” for messages sent from the supervisory controller 12. The Message ID field contains a unique identifier identifying a specific message. The Current Subsystem State field contains a text message indicating a current operational state of the brake controller 14 or the steering controller 16. For example, the Current Subsystem State field can contain one of the following text messages: (i) power up, (ii) normal, (iii) degraded, (iv) emergency, (v) failure, (vi) service, and (vii) power down. The Fault Type field contains a text message indicating a current fault type associated with a detected fault condition. For example, the Fault Type Field can contain one of the following text messages: (i) controller fault, (ii) actuator fault, (iii) sensor fault, (iv) power fault, and (v) communication fault. The Commanded Subsystem State field contains a text message indicating a commanded operational state in which a controller is being commanded to transition to. In particular, the Commanded Subsystem State field is utilized in messages sent from the supervisory controller 12 for commanding another controller to transition into a desired operational state. The supervisor controller 12 communicates through the communication bus 30 with the brake controller 14 and the steering controller 16. The supervisory controller 12 includes a microprocessor (not shown) for implementing software instructions therein.

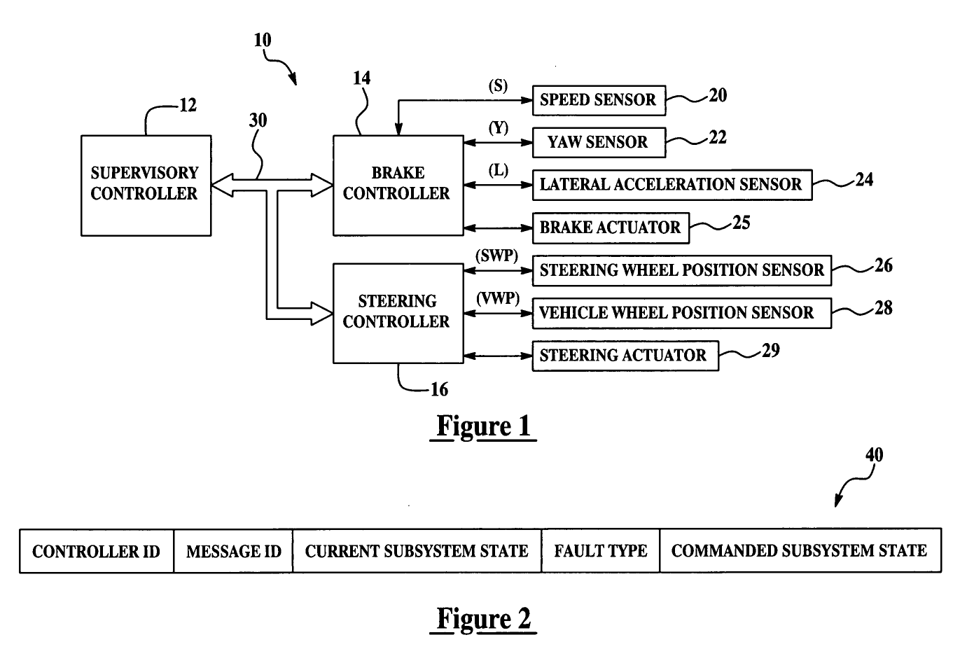

Referring to FIG. 1, the brake controller 14 is provided to monitor operation of the speed sensor 20, the yaw sensor 22, and the lateral acceleration sensor 24. The brake controller 14 is configured to control the brake actuator 25, based on the signals from the speed sensor 20, the yaw sensor 22, and the lateral acceleration sensor 24. The brake controller 14 is further provided to send messages having the message format 40 to the supervisory controller 12 to communicate both a current subsystem state of the brake controller 14 and any fault conditions detected by the brake controller 14. The brake controller 14 is further provided to receive messages from the supervisor controller 12 and to transition to desired operational states identified in the messages. The brake controller 14 communicates through the communication bus 30 with the supervisory controller 12. The brake controller 14 includes a microprocessor (not shown) for implementing software instructions therein.

The speed sensor 20 is provided to generate a signal (S) indicative of a vehicle speed. The speed sensor 20 is operably coupled to the brake controller 14 and transmits the signal (S) to the brake controller 14.

The yaw sensor 22 is provided to generate a signal (Y) indicative of a yaw rate of a vehicle (not shown). The yaw sensor 22 is operably coupled to the brake controller 14 and transmits the signal (Y) to the brake controller 14.

The lateral acceleration sensor 24 is provided to generate a signal (L) indicative of a lateral acceleration associated with a vehicle (not shown). The lateral acceleration sensor 24 is operably coupled to the brake controller 14 and transmits the signal (L) to the brake controller 14.

The brake actuator 25 is provided to actuate a braking device of the vehicle. The brake actuator 25 is operably coupled to the brake controller 14, and is activated in response to a control signal from the brake controller 14.

The steering controller 16 is provided to monitor the steering wheel position sensor 26 and the vehicle wheel position sensor 28. The steering controller 14 is configured to control the steering actuator 29, based on the signals from the steering wheel position sensor 26 and the vehicle wheel position sensor 28. The steering controller 16 is further provided to send messages having the message format 40 to the supervisory controller 12 to communicate both a current subsystem state of the steering controller 16 and any fault conditions detected by the steering controller 16. The steering controller 16 is further provided to receive messages from the supervisor controller 12 and to transition to desired operational states identified in the messages. The steering controller 16 communicates through the communication bus 30 with the supervisory controller 12. The steering controller 16 includes a microprocessor (not shown) for implementing software instructions therein.

The steering wheel position sensor 26 is provided to generate a signal (SWP) indicative of an operational position of a vehicle steering wheel (not shown). The steering wheel position sensor 26 is operably coupled to the steering controller 16 and transmits the signal (SWP) to the steering controller 16.

The vehicle wheel position sensor 28 is provided to generate a signal (VWP) indicative of an operational position of a vehicle wheel (not shown). The vehicle wheel position sensor 28 is operably coupled to the steering controller 16 and transmits the signal (VWP) to the steering controller 16.

The steering actuator 29 is provided to actuate a steering device (not shown) of a vehicle: The steering actuator 29 is operably coupled to the steering controller 16, and is activated in response to a control signal from the steering controller 16.

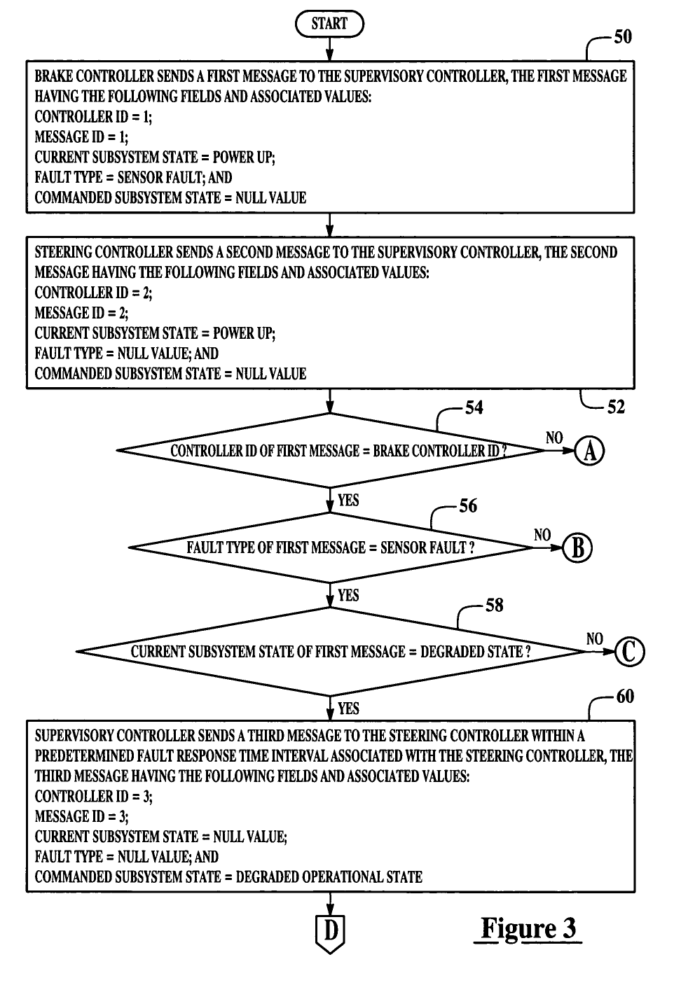

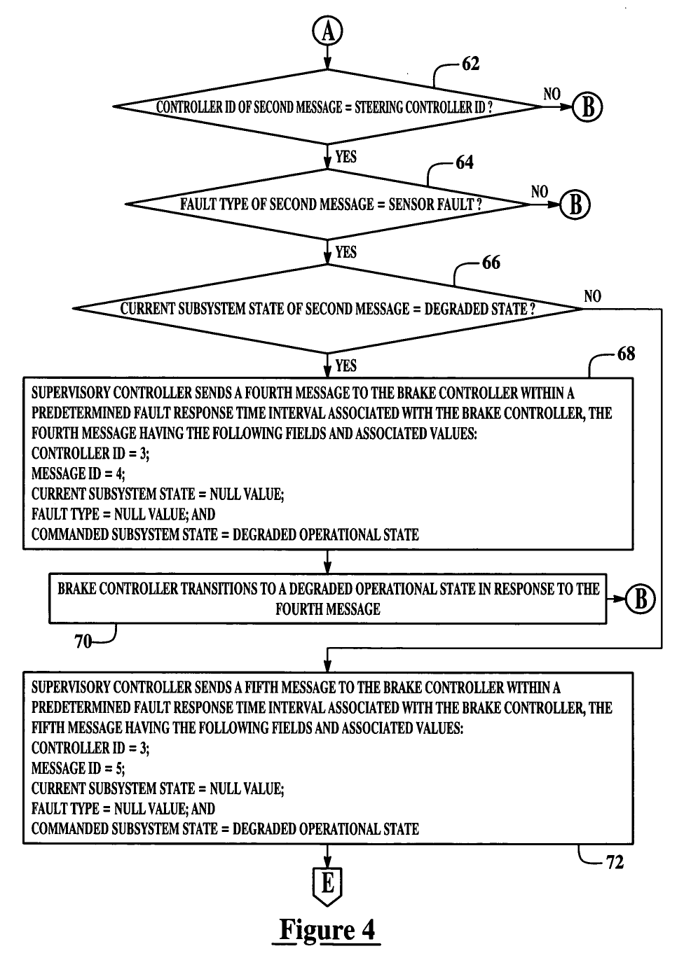

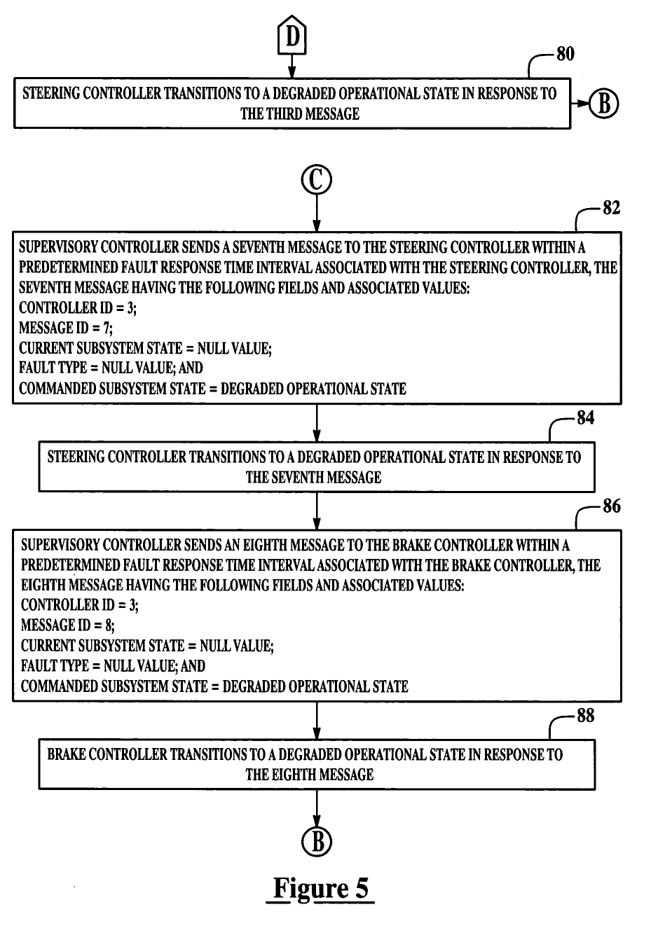

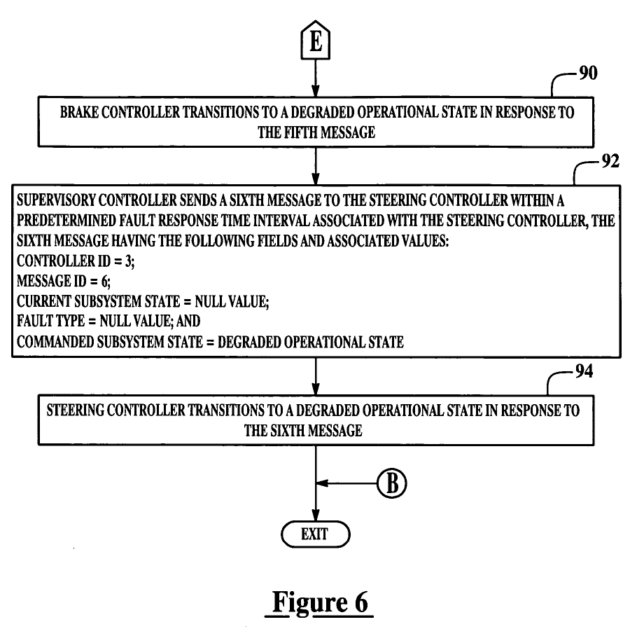

Referring to FIGS. 3-6, a method for monitoring vehicle controllers in accordance with another exemplary embodiment will now be described. The method can be of implemented utilizing software algorithms executed on the supervisor controller 12, the brake controller 14, and the steering controller 16, of the vehicle diagnostics system 10 described above.

At step 50, the brake controller 14 sends a first message to the supervisory controller 12. The first message has the following fields and associated values: Controller ID=1; Message ID=1; Current Subsystem State=power up; Fault Type=sensor fault; and Commanded Subsystem State=null value.

At step 52, the steering controller 16 sends a second message to the supervisory controller 12. The second message has the following fields and associated values: Controller ID=2; Message ID=2; Current Subsystem State=power up; Fault Type=null value; and Commanded Subsystem State=null value.

At step 54, the supervisory controller 12 makes a determination as to whether the Controller ID of the first message is equal to a predetermined brake controller ID. If the value of step 54 equals “yes,” the method advances to step 56. Otherwise, the method advances to step 62.

At step 56, the supervisory controller 12 makes a determination as to whether the Fault Type field of first message indicates a sensor fault. If the value of step 56 equals “yes,” the method advances to step 58. Otherwise, the method is exited.

At step 58, the supervisor controller 12 makes a determination as to whether the Current Subsystem State of first message indicates a degraded state. If the value of step 58 equals “yes,” the method advances to step 60. Otherwise, the method advances to step 82.

At step 60, the supervisory controller 12 sends a third message to the steering controller 16 within a predetermined fault response time interval associated with the steering controller 16. The third message has the following fields and associated values: Controller ID=3; Message ID=3; Current Subsystem State=null value; Fault Type=null value; and Commanded Subsystem State=degraded operational state. After step 60, the method advances to step 80.

At step 80, the steering controller 16 transitions to a degraded operational state in response to the third message. After step 80, the method is exited.

Referring again to step 54, when the value of step 54 equals “no,” the method advances to step 62.

At step 62, the supervisory controller 12 makes a determination as to whether the Controller ID of the second message is equal to a predetermined steering controller ID. If the value of step 62 equals “yes,” the method advances to step 64. Otherwise, the method is exited.

At step 64, the supervisory controller 12 makes a determination as to whether the Fault Type field of second message indicates a sensor fault. If the value of step 64 equals “yes”, the method advances to step 66. Otherwise, the method is exited.

At step 66, the supervisory controller 12 makes a determination as to whether the Current Subsystem State of first message indicates a degraded state. If the value of step 66 equals “yes”, the method advances to step 72. Otherwise, the method advances to step 68.

At step 68, the supervisory controller 12 sends a fourth message to the brake controller 14 within a predetermined fault response time interval associated with the brake controller 14. The fourth message has the following fields and associated values: Controller ID=3; Message ID=4; Current Subsystem State=null value; Fault Type=null value; and Commanded Subsystem State=degraded operational state.

At step 70, the brake controller 14 transitions to a degraded operational state in response to the fourth message. After step 70, the method is exited.

Referring again to step 66, when the value of step 66 equals “no,” the method advances to step 72.

At step 72, the supervisory controller 12 sends a fifth message to the brake controller 14 within a predetermined fault response time interval associated with the brake controller 14. The fifth message has the following fields and associated values: Controller ID=3; Message ID=5; Current Subsystem State=null value; Fault Type=null value; and Commanded Subsystem State=degraded operational state. After step 72, the method advances to step 90.

At step 90, the brake controller 14 transitions to a degraded operational state in response the fifth message.

At step 92, the supervisory controller 12 sends a sixth message to the steering controller 16 within a predetermined fault response time interval associated with the steering controller 16. The sixth message has the following fields and associated values: Controller ID=3; Message ID=6; Current Subsystem State=null value; Fault type=null value; and Commanded Subsystem State=degraded operational state.

At step 94, the steering controller 16 transitions to a degraded operational state in response to the sixth message. After step 94, the method is exited.

Referring again to step 58, when the value of step 58 equals “no,” the method advances to step 82.

At step 82, the supervisory controller 12 sends a seventh message to the steering controller 16 within a predetermined fault response time interval associated with the steering controller 16. The seventh message has the following fields and associated values: Controller ID=3; Message ID=7; Current Subsystem State=null value; Fault Type=null value; and Commanded Subsystem State=degraded operational state.

At step 84, the steering controller 16 transitions to a degraded operational state in response to the seventh message.

At step 86, the supervisory controller 12 sends an eighth message to the brake controller 14 within a predetermined fault response time interval associated with the brake controller 14. The eighth message has the following fields and associated values: Controller ID=3; Message ID=8; Current Subsystem State=null value; Fault Type=null value; and Commanded Subsystem State=degraded operational state.

At step 88, the brake controller 14 transitions to a degraded operational state in response to the eighth message. After step 88, method is exited.

The vehicle diagnostics system and the method for monitoring operation of controllers provides a substantial advantage over other systems and methods. In particular, vehicle diagnostics system and method provide a technical effect of utilizing a supervisory controller to notify other vehicle subsystem controllers that a fault condition in one or more of the vehicle subsystems has occurred and to coordinate corrective actions among the vehicle subsystems that could be affected by the fault condition.

As described above, the above-described method can be embodied in the form of computer-implemented processes and apparatuses for practicing those processes. In an exemplary embodiment, the method is embodied in computer program code executed by one or more elements. The present method may be embodied in the form of computer program code containing instructions embodied in tangible media, such as floppy diskettes, CD-ROMs, hard drives, flash memory, or any other computer-readable storage medium, wherein, when the computer program code is loaded into and executed by a computer, the computer becomes an apparatus for practicing the invention. The present method can also be embodied in the form of computer program code, for example, whether stored in a storage medium, loaded into and/or executed by a computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A vehicle diagnostic system, comprising:
a first controller configured to control operation of a first device, the first controller having a first operational state, the first controller configured to generate a first message having a fault status value when a fault condition is detected;
a second controller configured to control operation of a second device, the second controller having a second operational state; and
a supervisory controller operably communicating with the first and second controllers, the supervisory controller configured to receive the first message and to send a second message to the second controller indicating a third operational state for the second controller in response to the first message, the second controller further configured to transition from the second operational state to the third operational state in response to the second message.

2. The vehicle diagnostic system of claim 1, wherein the second controller has a predetermined fault response time interval, the supervisory controller configured to receive the first message at a first time and to send the second message to the second controller at a second time, the time interval between the first time and the second time being less than or equal to the predetermined fault response time interval of the second controller.

3. The vehicle diagnostic system of claim 1, wherein the supervisory controller is further configured to send a third message to the first controller indicating a fourth operational state for the first controller in response to the first message, the first controller further configured transition from the first operational state to the fourth operational state in response to the third message.

4. The vehicle diagnostic system of claim 3, wherein the first controller has a predetermined fault response time interval, the supervisory controller configured to receive the first message at a first time and to send the third message to the first controller at a second time, the time interval between the first time and the second time being less than or equal to the predetermined fault response time interval of the first controller.

5. The vehicle diagnostic system of claim 1, wherein the fault status value indicates at least one of a controller fault condition, an actuator fault condition, a sensor fault condition, an electrical power fault condition, and a communications fault condition.

6. The vehicle diagnostic system of claim 1, further comprising a sensor configured to generate a signal that is received by the first controller, the first controller generating the first message having the fault status value when the signal indicates a sensor fault condition.

7. The vehicle diagnostic system of claim 1, wherein the first device comprises a vehicle brake actuator.

8. The vehicle diagnostic system of claim 5, wherein the second device comprises a vehicle steering actuator.

9. A method for monitoring vehicle controllers, comprising:
generating a first message having a fault status value when a fault condition is detected, utilizing a first controller, the first controller controlling a first device;
receiving the first message at a supervisory controller and sending a second message from the supervisory controller to a second controller indicating a second operational state for the second controller, in response to the first message; and
transitioning an operational state of the second controller from a third operational state to the second operational state in response to the second message.

10. The method of claim 9, wherein the second controller has a predetermined fault response time interval, and a time interval between receipt of the first message by the supervisory controller and the sending of the second message from the supervisory controller to the second controller is less than or equal to the predetermined fault response time interval of the second controller.

11. The method of claim 9, further comprising:
sending a third message from the supervisory controller to the first controller indicating a fourth operational state for the first controller in response to the first message; and
transitioning an operational state of the first controller from the first operational state to the fourth operational state in response to the third message.

12. The method of claim 11, wherein the first controller has a predetermined fault response time interval, and a time interval between receipt of the first message by the supervisory controller and the sending of the third message from the supervisory controller to the first controller is less than or equal to the predetermined fault response time interval of the first controller.

13. The method of claim 9, wherein the fault status value indicates at least one of a controller fault condition, an actuator fault condition, a sensor fault condition, an electrical power fault condition, and a communications fault condition.
